(19) United States
(12) Patent Application Publication
(10) Pub. No.: US 2001/0001781 A1
(43) Pub. Date: May 24, 2001

(54) ZEOLITE-BASED CATALYST MATERIAL, THE PREPARATION THEREOF AND THE USE THEREOF IN CONVERTING HYDROCARBONS

(75) Inventors: CHARLES A. DRAKE, NOWATA, OK (US); JIANHUA YAO, BARTLESVILLE, OK (US)

Correspondence Address: RICHMOND HITCHCOCK FISH & DOLLAR, P O BOX 2443, BARTLESVILLE, OK, 74005

(73) Assignee: Charles A. Drake

(21) Appl. No.: 09/220,957

(22) Filed: Dec. 28, 1998

(51) Int. Cl. B01J 29/06

(52) U.S. Cl. 502/64; 585/418

(57) ABSTRACT

A process in which a hydrocarbon feedstock containing non-aromatics is passed consecutively through a catalyst arrangement of two catalyst compositions, (1) a steam treated zinc-promoted zeolite and (2) a zeolite that has been subjected to a heat treatment, under hydrocarbon conversion conditions to yield a product containing lower olefins and BTX. An arrangement of two catalyst compositions, (1) a steam treated zinc-promoted zeolite and (2) a zeolite that has been subjected to a heat treatment, for consecutive contact with a hydrocarbon feedstock.

### BACKGROUND OF THE INVENTION

The invention relates to a process for the conversion of a cracked gasoline feedstock to ethylene, propylene and BTX (benzene, toluene and xylenes) in the presence of an arrangement of zeolite-based catalysts.

It is known to catalytically crack non-aromatic gasoline boiling range hydrocarbons, particularly hydrocarbons such as paraffins and olefins, to lower olefins (such as ethylene and propylene) and aromatic hydrocarbons (such as benzene, toluene and xylenes) in the presence of catalysts which contain a zeolite (such as ZSM-5), as is described in an article by N. Y. Chen et al. in Industrial & Engineering Chemistry Process Design and Development, Volume 25, 1986, pages 151-155. The reaction products of the catalytic cracking processes contain a multitude of hydrocarbons such as unconverted C₅+ alkanes, lower alkanes (methane, ethane, propane) lower alkenes (ethylene and propylene), C₆-C₈ aromatic hydrocarbons (benzene, toluene, xylenes and ethylbenzene) and C₉+ aromatic hydrocarbons. It can be desirable to further process the product from a catalytic gasoline cracking operation to increase the yield of compounds that, in a current market, are relatively more valuable than other products of gasoline cracking. The cracking operation yield of lower olefins (such as ethylene and propylene) and BTX (benzene, toluene, xylene and ethylbenzene) aromatics, for example, can be increased using the improved zeolite catalyst compositions of this invention.

### SUMMARY OF THE INVENTION

It is an object of this invention to at least partially convert hydrocarbons to ethylene, propylene and BTX aromatics.

Another object of this invention is to provide an improved zeolite-based catalyst arrangement that utilized in the conversion of hydrocarbons gives an improved yield of lower olefins and BTX aromatics.

A further object of this invention is to provide a method for making an improved zeolite-based catalyst arrangement that utilized in the conversion of hydrocarbons yields a product having an improved yield of lower olefins and BTX aromatics.

The invention is an arrangement of two catalyst compositions, (1) a steam treated zinc-promoted zeolite and (2) a zeolite that has been subjected to a heat treatment, for contact with a hydrocarbon feedstock and a process in which a hydrocarbon feedstock containing non-aromatics is passed consecutively through the catalyst arrangement under hydrocarbon conversion conditions to yield lower olefins and BTX.

Other objects and advantages of the invention will become apparent from the detailed description and the appended claims.

### DETAILED DESCRIPTION OF THE INVENTION

The zeolite material used in making the inventive compositions can be any zeolite which when contacted with non-aromatic hydrocarbons under suitable operating conditions is effective in the conversion of non-aromatic hydrocarbons to aromatic hydrocarbons. Preferably, the zeolite has a constraint index (as defined in U.S. Pat. No. 4,097,367, which is incorporated here by reference) in the range of about 0.4 to about 12, more preferably about 2 to about 9. Generally the molar ratio of SiO₂ to Al₂O₃ in the crystalline framework of the zeolite is at least about 5:1 and can range up to infinity. Preferably the molar ratio of SiO₂ to Al₂O₃ in the zeolite framework is about 8:1 to about 200:1, more preferably about 12:1 to about 100:1. Preferred zeolites include ZSM-5, ZSM-8, ZSM-11, ZSM-12, ZSM-35, ZSM-38 and mixtures thereof. Some of these zeolites are also known as “MFI” or “Pentasil” zeolites. The presently most preferred zeolite is ZSM-5.

The zeolite can be used directly, as received from the manufacturer, or it can be subjected to a heat treatment, following the conditions set out below, before being used in the preparation of a catalyst by the first embodiment of this invention. In the heat treatment, if employed, the zeolite is exposed, by any suitable method known in the art, to a gas atmosphere under temperature and pressure conditions and for a period of time that is suitable to provide a desired heat treated product.

The gas used in the heat treatment of the zeolite can be selected from the group consisting of inert gases (nitrogen, helium, argon and the like), reducing gases (carbon monoxide, hydrogen and the like), air, oxygen and steam. The preferred gas is selected from among air, oxygen, nitrogen, steam and mixtures thereof. Most preferably, the treatment gas is selected from among air, oxygen, nitrogen and mixtures of two thereof.

Generally, this heat treatment can be conducted at a pressure in a range from below atmospheric pressure to about 1000 pounds per square inch absolute (psia). More typically, however, the pressure range is from about atmospheric to about 100 psia. The temperature of this heat treatment is generally in the range of about 250° C. to about 800° C. Preferably, this temperature range is from about 350° C. to about 700° C. and, most preferably, the temperature of this heat treatment is in a range of about 450° C. to about 600° C.

The time period for conducting this heat treatment must be sufficient to provide a material that is substantially dry, i.e., free of water. Generally, the period of time during which the zeolite is exposed to treating gas at appropriate conditions of temperature and pressure can range from about 0.1 hour to about 30 hours. Preferably, this heat treatment is conducted for a time period in the range of about 0.25 hour to about 20 hours and, most preferably, from about 0.5 hour to about 10 hours.

Addition of Zinc

After the heat treatment, if employed, the washed, zeolite is further treated to provide a zinc-containing catalyst composition. The zinc can be incorporated into either, in accordance with the first embodiment of this invention, a zeolite that has not been acid leached or, in accordance with the second embodiment of this invention, an acid leached zeolite. Any suitable means for incorporating metallic elements into a substrate material. A preferred method of incorporation is the use of any incipient wetness technique for impregnating the acid leached zeolite substrate with the metal. This preferred method uses a liquid impregnation solution containing the desired concentration of zinc to ultimately provide a final catalyst composition having the desired concentration of zinc.

As used herein, the term “zinc” refers to elemental zinc, inorganic zinc compounds, organic zinc compounds and mixtures of any two or more thereof. Examples of suitable zinc compounds include zinc acetate dihydrate, zinc acetylacetonate hydrate, zinc bromide, zinc carbonate hydroxide, zinc chloride, zinc borate, zinc silicate, zinc aluminate, zinc chromite, zinc cyclohexanebutyrate dihydrate, zinc 2-ethylhexanoate, zinc fluoride, zinc hexafluoroacetylacetonate dihydrate, zinc iodide, zinc molybdate, zinc naphthenate, zinc nitrate hexahydrate, zinc oxide, zinc perchlorate hexahydrate, zinc phosphate hydrate, zinc phosphide, zinc protoporphyrin, zinc sulfate monohydrate, zinc sulfide, zinc telluride, zinc tetrafluoroborate hydrate, zinc titanate and zinc trifluoromethane sulfonate. Inorganic zinc compounds are particularly preferred. The most preferred zinc compound is zinc nitrate.

Zinc is incorporated into the zeolite to form a mixture of zeolite and zinc. The zinc can be incorporated into the zeolite by any suitable means or method known in the art for incorporating metallic elements into a substrate material. One method is to mix the zeolite with at least one anhydrous zinc compound, followed by a heat treatment preferably at about 700-800° C. for about 1-10 hours in an inert gas stream. Another method, presently preferred for impregnating zeolite that has not been acid leached, uses a liquid impregnation solution containing a concentration of zinc sufficient to ultimately provide the final inventive composition with the concentration of zinc in the required range. Yet another method, presently preferred for incorporating zinc into an acid leached zeolite, uses an ion exchange technique to provide an amount of incorporated zinc in the required range.

If zinc is incorporated into the zeolite with an aqueous solution of a zinc compound, the preferred impregnation solution is an aqueous solution formed by dissolving a salt of zinc(preferably ZnCl₂) in water. It is acceptable, however, to use a somewhat acidic solution to aid in the dissolution of the zinc salt. The zinc-impregnated, zeolite is then heat treated, preferable at about 700-800° for about 1-10 hours in an inert gas stream.

For the incorporation of zinc into the zeolite any suitable zinc salt can be mixed with the zeolite and the zinc salt/zeolite mixture then washed with an aqueous solution of a suitable ion exchange agent, preferably 1M ammonium nitrate (NH₄NO₃). The washed catalyst can then be filtered, washed with deionized water, dried and, preferably, calcined to obtain zinc-incorporated zeolite.

The amount of zinc incorporated or impregnated into the zeolite should provide a concentration effective to assure predetermined aromatics and olefin conversion yields employing the catalyst composition in the conversion of a hydrocarbon feedstock. Generally, the weight percent of zinc present in the impregnated zeolite is in a range of up to about 10 weight percent of the impregnated zeolite. The preferred concentration of zinc in the impregnated zeolite is in the range of about 0.05 to about 8 weight percent and, more preferably, from about 0.1 to about 6 weight percent.

Steam Treatment

Both the zeolite and the zinc impregnated zeolite are subjected, in accordance with this invention, to a steam treatment in which both the zeolite and the zinc impregnated zeolite are individually contacted with a water vapor saturated stream of gas for a period of time at an elevated temperature to produce a steamed product. The carrier gas for the water vapor is a gas that is inert in the presence of water to the components of the catalyst. A preferred carrier gas is helium. The period of contact can be in the range of up to about 24 hours, preferably about 1 to about 15 hours and more preferably about 2 to about 12 hours. The temperature of the steam treatment can be in the range of about 575° C. to about 675° C., more preferably about 585° C. to about 665° C., and most preferably about 600° C. to about 650° C. The steam treatment, as in the circumstance of the zinc promoted zeolite of this invention, can be provided at different temperature levels for different periods of time. For example, the zinc promoted zeolite of this invention is preferably treated for 1.5 hours at 600° C. followed by an immediate treatment at 650° C. for 2 hours.

Both the steam treated zeolite and the steam treated zinc impregnated zeolite can be subjected to a subsequent heat treating by which it is exposed by any suitable method known in the art to a gas atmosphere under temperature and pressure conditions and for a period of time to provide a desired heat treated material. The gas used in the heat treatment of the zeolite can be selected from the group consisting of inert gases (nitrogen, helium, argon and the like), reducing gases (carbon monoxide, hydrogen and the like), air, oxygen and steam. The preferred gas is selected from among air, oxygen, nitrogen, steam and mixtures thereof Most preferably, the treatment gas is selected from among air, oxygen, nitrogen and mixtures of two thereof.

Generally, this heat treatment can be conducted at a pressure in a range from below atmospheric pressure to about 1000 pounds per square inch absolute (psia). More typically, however, the pressure range is from about atmospheric to about 100 psia. The temperature of this heat treatment is generally in the range of about 500° C. to about 1000C. Preferably, this temperature range is from about 600° C. to about 900° C. and, most preferably, the temperature of this heat treatment is in a range of about 650° C. to about 850° C.

The time period for conducting this heat treatment must be sufficient to provide a material that is substantially dry, i.e., free of water. Generally, the period of time during which the zeolite is exposed to treating gas at appropriate conditions of temperature and pressure can range from about 0.1 hour to about 30 hours. Preferably, this heat treatment is conducted for a time period in the range of about 0.25 hour to about 20 hours and, most preferably, from about 0.5 hour to about 10 hours and results in a calcined, steam treated product suitable for use in a catalyst bed.

The catalyst compositions described herein can also contain an inorganic binder (also called matrix material) preferably selected from among alumina, silica, alumina-silica, aluminum phosphate, clays (such as bentonite) and mixtures thereof. The content of the impregnated zeolite component of the mixture of impregnated zeolite and inorganic binder is about 50-99 (preferably about 50-80) weight percent. The content of the above-listed inorganic binders in the mixture of impregnated zeolite and inorganic binder is about 1-50 weight percent. Generally, the impregnated zeolite and organic binder components are compounded and subsequently shaped (such as by pelletizing, extruding or tableting). Generally the surface area of the compounded composition is about 50-700 m²/g, and the particle size is about 1-10 mm. The compounded zeolite composition can be subjected to heat treating as described immediately above.

The process of this invention applies most specifically to the conversion of cracked hydrocarbon feedstocks to aromatic hydrocarbons. The preferred feedstocks of this invention are cracked hydrocarbon feedstocks from the catalytic cracking (e.g., fluidized catalytic cracking and hydrocracking) of gas oils and the thermal cracking of light hydrocarbons, naphthas, gas oils, reformates and straight-run gasoline. The cracked gasoline feedstock generally comprises hydrocarbons containing 2-16 carbon atoms per molecule chosen from among paraffins (alkanes) and/or olefins (alkenes) and/or naphthenes (cycloalkanes). The most preferred feedstock for processes of this invention is a cracked gasoline derived from the fluidized catalytic cracking of gas oil, suitable for use as at least a gasoline blend stock generally having a boiling range of from about 80° F. to about 430° F. The boiling range of the cracked hydrocarbon feedstock is determined by the standard ASTM method for measuring the initial boiling point and the end-point temperatures. Generally the content of paraffins exceeds the combined content of olefins, naphthenes, and aromatics (if present). The process of this invention is principally directed to the aromatization of a cracked hydrocarbon feedstock. It is specifically noted that the alkylation of aromatic compounds is substantially absent because either the reaction does not take place or insubstantial quantities of aromatics are present in the feedstock in the process of this invention.

Cracked hydrocarbon feedstock and the catalyst compositions can be contacted within a reaction zone in any suitable manner, but, according to this invention, the hydrocarbon feedstock must be contacted first with the steam treated zeolite and the effluent from this contacting must be contacted subsequently with the steam treated zinc-promoted zeolite. The contacting can be operated with discrete catalyst beds in the same or separate reactor vessels as a batch process or, preferably, as a continuous process. In either a batch or a continuous process a solid catalyst bed or beds can be employed arranged so that the steam treated zeolite is upstream of the steam treated zinc-promoted zeolite in the flow of the feedstock. Each of these modes of operation has known advantages and disadvantages so that one skilled in the art can select the mode most suitable for a particular feedstock to be contacted with the inventive catalyst arrangement.

Contacting the hydrocarbon feedstock and the catalyst composition is preferably carried out in a conversion reaction zone which contains the catalyst compositions in the specific order of contact with the hydrocarbon feedstock set out above and employing reaction conditions that promote the formation of olefins, preferably light olefins, and aromatics, preferably BTX, from at least a portion of the hydrocarbons in the cracked hydrocarbon feedstock. The reaction temperature employed in the contacting is in the range of from about 400° C. to about 900° C., preferably, from about 500° C. to about 800° C. and, more preferably, from 600° C. to about 700° C. The pressure employed in the contacting can range from subatmospheric up to about 500 psia and, preferably, from about atmospheric to about 400 psia.

The flow rate at which the cracked hydrocarbon feedstock is charged to the conversion reaction zone for contact with the catalyst composition is selected to provide a weight hourly space velocity (WHSV) in a range having an upward limit of about 1000 hour⁻¹. The term “weight hourly space velocity”, as used herein, shall mean the numerical ratio of the rate at which a cracked hydrocarbon feedstock is charged to the conversion reaction zone in pounds per hour divided by the pounds of catalyst contained in the conversion reaction zone to which the hydrocarbon is charged. The preferred WHSV of the feed to the conversion reaction zone, or contacting zone, can be in the range of from about 0.25 hour⁻¹ to about 250 hour⁻¹ and, more preferably, from about 0.5 hour⁻¹ to about 100 hour⁻¹.

The following examples are presented to further illustrate this invention and are not to be construed as unduly limiting its scope.

### EXAMPLE I

This example illustrates the preparation of catalysts which were subsequently tested as catalysts in the conversion to ethylene, propylene and BTX of a gasoline sample, which had been produced in a commercial fluidized catalytic cracking unit (FCC).

Catalyst A (Control)- Catalyst Bed Packed with Zeolite, Steam Treated at 650° C.

A 50.0 gm quantity of a commercially available ZSM-5 catalyst provided by United Catalysts Inc. of Louisville, Ky. under their product designation “T-4480” was charged to a steam reactor and treated for 6 hours at 650° C. with a helium flow of 1000 ml/hr and a water flow of 20 ml/hr.

A 4.0 gm quantity of the catalyst produced above was packed into a catalyst tube reactor (see Example II, below).

Catalyst B (Control)- Catalyst Bed Packed with ZnNO₃ Impregnated Zeolite, Steam Treated at 600° C. and then 650° C.

A 20.0 gram quantity of the above-described ZSM-5 catalyst was calcined and impregnated to incipient wetness with an 1.0 gram quantity of a 1.0 weight percent aqueous solution of hydrated zinc nitrate (Zn(NO₃)₂.6H₂O) to provide an impregnated zeolite containing 1.0 weight percent Zn(NO₃). The Zn(NO₃) impregnated zeolite was dried on a hot plate, then dried for 3 hours at 120° C. and then calcined for 3 hours at 520° C. A 5 gram quantity of this calcined, zinc impregnated zeolite was then steamed at 600° C. for 1.5 hours in the presence of 4 ml/hr water, at 650° C. for 1 hour in the presence of 5.5 ml/hr water and at 650° C. for 1 hour in the presence of 6 ml/hr water.

A 4 gram quantity of the catalyst produced above was packed into a catalyst tube reactor.

Catalyst C (Invention)- Catalyst Bed Packed with (1) ZnNO₃ Impregnated Zeolite, Steam Treated at 600° C. and then 650° C. and (2) Zeolite, Steam Treated at 650° C.

A 2 gram quantity of the above-described Catalyst B was packed into the upstream end of a catalyst tube reactor and a 2 gram quantity of Catalyst A was packed into the downstream end of this catalyst tube reactor.

Catalyst D (Control)- Catalyst Bed Packed with (1) Zeolite, Steam Treated at 650° C. and (2) ZnNO₃ Impregnated Zeolite, Steam Treated at 600° C. and then 650° C.

A 2 gram quantity of the above-described Catalyst A as packed into the upstream end of a catalyst tube reactor and a 2 gram quantity of Catalyst B was packed into the downstream end of this catalyst tube reactor.

Catalyst E (Control)- Catalyst Bed Packed with (1) Zeolite, Steam Treated at 650° C. and (2) ZnNO₃ Impregnated Zeolite, Steam Treated at 600° C. and then 650° C.

A 2 gram quantity of the above-described Catalyst A as packed into the upstream end of a catalyst tube reactor and a 2 gram quantity of Catalyst B was packed into the downstream end of this catalyst tube reactor.

### EXAMPLE II

This example illustrates the use of the Zeolite materials described in Example I as catalysts in the conversion of a gasoline feed to incremental aromatics such as benzene, toluene and xylene (BTX) and lower olefins (ethylene and propylene).

For each of the test runs, a 4.0 g sample of the catalyst materials described in Example I was placed into a stainless steel tube reactor (length: about 18 inches; inner diameter: about 0.5 inch). Gasoline boiling range feedstock from a catalytic cracking unit of a refinery was passed through the reactor at a flow rate of about 2 WHSV, at a temperature of about 600° C. and at atmospheric pressure (about 0 psig). The formed reaction product exited the reactor tube and passed through several ice-cooled traps. The liquid portion remained in these traps and was weighed. The volume of the gaseous portion which exited the traps was measured in a “wet test meter”. Liquid and gaseous product samples (collected at hourly intervals) were analyzed by means of a gas chromatograph. Results of the test runs for Catalysts A through C. are summarized in Table I. All test data were obtained up to 8 hours on stream except for Catalyst E which was obtained up to 8.3 hours on stream.

TABLE 1

| | Product Yield (Wt %) | | | | BTX Activity |
|---|---|---|---|---|---|
| Catalyst | Ethylene | Propylene | BTX | Total | Decline (%/hr) |
| A(Cont.) | 9.6 | 13.8 | 27.8 | 51.2 | 0.07 |
| B(Cont.) | 8.5 | 11.2 | 39.3 | 59.0 | 0.48 |
| C(Inv.) | 9.2 | 13.7 | 33.2 | 56.1 | 0.05 |
| D(Cont.) | 9.2 | 13.0 | 33.4 | 55.6 | 0.35 |
| E(Cont.) | 8.8 | 12.5 | 35.4 | 56.7 | 0.39 |

The test results bear out previous findings that use of Catalyst A (Control), a steam treated ZSM-5 catalyst, produces a greater amount of the currently more economically desirable olefins with lower BTX yields as compared to the product of Catalyst B (Control), a steam treated zinc-promoted ZSM-5 catalyst, which provides higher BTX yields and lower olefin yields.

The use of combinations of the two catalysts above placed in equal amounts with one upstream of the other so that the feedstock flows first through one catalyst then the other showed that placing Catalyst B first, as in Catalyst C, or Catalyst A first, as in Catalyst D-E, produced results of olefin and BTX production that are relatively equal but the decline in BTX activity (an indication of catalyst stability) was significantly greater, i.e. less desirable, with placement of Catalyst A to contact the feedstock first as compared to placement of Catalyst B as first to contact the feedstock. The catalyst systems for Catalysts D and E were duplicates, but the time on stream was 8.3 hours for Catalyst E as compared to 8 hours for the other catalysts.

Reasonable variations, modifications and adaptations can be made within the scope of the disclosure and the appended claims without departing from the scope of this invention.

That which is claimed is:

1. An arrangement of catalyst for use in converting hydrocarbons in which the arrangement comprises:
(A) a bed of steam treated zinc-promoted zeolite catalyst and
(B) a bed of steam treated zeolite catalyst arranged for flow of feedstock through (A) and the effluent from (A) subsequently flowing through (B).

2. An arrangement of catalyst according to claim 1 wherein the steam treated zeolite catalyst is prepared by the method comprising treating the zeolite at 575° C.-675° C. in the presence of water vapor and a carrier gas inert to the catalyst components thereby providing a steam treated zeolite.

3. An arrangement of catalyst according to claim 2 wherein steam treating the zeolite is carried out at about 650° C.

4. An arrangement of catalyst according to claim 2 wherein the steam treated zeolite catalyst is further treated by calcining the steam treated zeolite to provide a calcined steam treated zeolite.

5. An arrangement of catalyst according to claim 2 wherein the steam treated zinc-promoted zeolite catalyst is prepared by the method comprising:
(A) impregnating a zinc compound into a zeolite to provide a zinc impregnated zeolite and
(B) steam treating the zinc impregnated zeolite at 575° C.-675° C. to provide a steam treated zinc impregnated zeolite.

6. An arrangement of catalyst according to claim 5 wherein the steam treating of the zinc-impregnated zeolite catalyst is carried out at a first level of about 600° C. followed by steam treatment at a second level of about 650° C.

7. An arrangement of catalyst according to claim 5 wherein the steam treated zinc-impregnated zeolite catalyst is further treated by calcining the steam treated zeolite to provide a calcined steam treated zinc impregnated zeolite.

8. An arrangement of catalyst according to claim 5 wherein the steam treated zinc-impregnated zeolite catalyst has been prepared by impregnating the zeolite to incipient wetness with the zinc compound.

9. An arrangement of catalyst according to claim 8 for preparing a catalyst composition wherein the zinc compound is zinc nitrate.

10. A hydrocarbon conversion process comprising contacting a cracked gasoline feedstock under conversion conditions with a catalyst arrangement according to claim 1.

11. A hydrocarbon conversion process comprising contacting a cracked gasoline feedstock under conversion conditions with a catalyst arrangement according to claim 2.

12. A hydrocarbon conversion process comprising contacting a cracked gasoline feedstock under conversion conditions with a catalyst arrangement according to claim 3.

13. A hydrocarbon conversion process comprising contacting a cracked gasoline feedstock under conversion conditions with a catalyst arrangement according to claim 4.

14. A hydrocarbon conversion process comprising contacting a cracked gasoline feedstock under conversion conditions with a catalyst arrangement according to claim 5.

15. A hydrocarbon conversion process comprising contacting a cracked gasoline feedstock under conversion conditions with a catalyst arrangement according to claim 6.

16. A hydrocarbon conversion process comprising contacting a cracked gasoline feedstock under conversion conditions with a catalyst arrangement according to claim 7.

17. A hydrocarbon conversion process comprising contacting a cracked gasoline feedstock under conversion conditions with a catalyst arrangement according to claim 8.

18. A hydrocarbon conversion process comprising contacting a cracked gasoline feedstock under conversion conditions with a catalyst arrangement according to claim 9.
